(19) United States
(12) Patent Application Publication
(10) Pub. No.: US 2020/0202220 A1
(43) Pub. Date: Jun. 25, 2020

(54) NEURAL NETWORK TRAINING METHOD AND DEVICE THEREOF AND COMPUTER STORAGE MEDIUM

(71) Applicant: HON HAI PRECISION INDUSTRY CO., LTD., New Taipei (TW)

(72) Inventors: JUNG-YI LIN, New Taipei (TW); I-HUA CHEN, New Taipei (TW); CHIN-PIN KUO, New Taipei (TW)

(21) Appl. No.: 16/285,496

(22) Filed: Feb. 26, 2019

(30) Foreign Application Priority Data
Dec. 19, 2018 (CN) 201811566670.4

(51) Int. Cl. G06N 3/08; G06N 3/04

(52) U.S. Cl. CPC G06N 3/086; G06N 3/04

(57) ABSTRACT

A neural network training method includes: obtaining a weight value between each two connected nodes of a neural network, wherein the neural network comprises a plurality of nodes and each of the plurality of nodes represents an activation function, the nodes are distributed in a plurality of layers arranged in order of computation, and each of the nodes is connected to all the nodes of a followed neighboring layer; integrating an input value and a corresponding weight value of each of the nodes using an evolutionary computation to dynamically generate an output value; correcting the weight value between each two connected nodes; integrating a corrected weight value and the output value of each of the nodes iteratively to obtain the output value of a corresponding connected node of a followed neighboring layer. A neural network training device and a computer storage medium are also provided.

### FIELD

The disclosure generally relates to neural network training.

### BACKGROUNDING

Neuron activation function used by the traditional neural network is fixed, and the weight value of each layer of neural network is adjusted by training methods such as gradient descent. However, the existing neural network training method cannot employ different data, and the obtained result has a low accuracy rate.

Therefore, there is room for improvement within the art.

### BRIEF DESCRIPTION OF THE DRAWING

Many aspects of the present disclosure can be better understood with reference to the drawings. The components in the drawings are not necessarily drawn to scale, the emphasis instead being placed upon clearly illustrating the principles of the disclosure. Moreover, in the drawings, like reference numerals designate corresponding parts throughout the views.

FIG. 1 is a schematic diagram of a neural network in accordance with an embodiment of the present disclosure.

FIG. 2 is a flow chart of a neural network training method in accordance with an embodiment of the present disclosure.

FIG. 3 is a schematic diagram of a first network structure of the neural network shown in FIG. 1.

FIG. 4 is a schematic diagram of a second network structure of the neural network shown in FIG. 1.

FIG. 5 is a hardware architecture diagram of a neural network training device in accordance with an embodiment of the present disclosure.

### DETAILED DESCRIPTION OF EMBODIMENTS

It will be appreciated that for simplicity and clarity of illustration, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts have been exaggerated to better illustrate details and features of the present disclosure. The description is not to be considered as limiting the scope of the embodiments described herein.

Several definitions that apply throughout this disclosure will now be presented. The term “comprising” means “including, but not necessarily limited to”; it specifically indicates open-ended inclusion or membership in a so-described combination, group, series, and the like. The term “coupled” is defined as connected, whether directly or indirectly through intervening components, and is not necessarily limited to direct physical connection. The connection can be such that the objects are permanently connected or releasably connected.

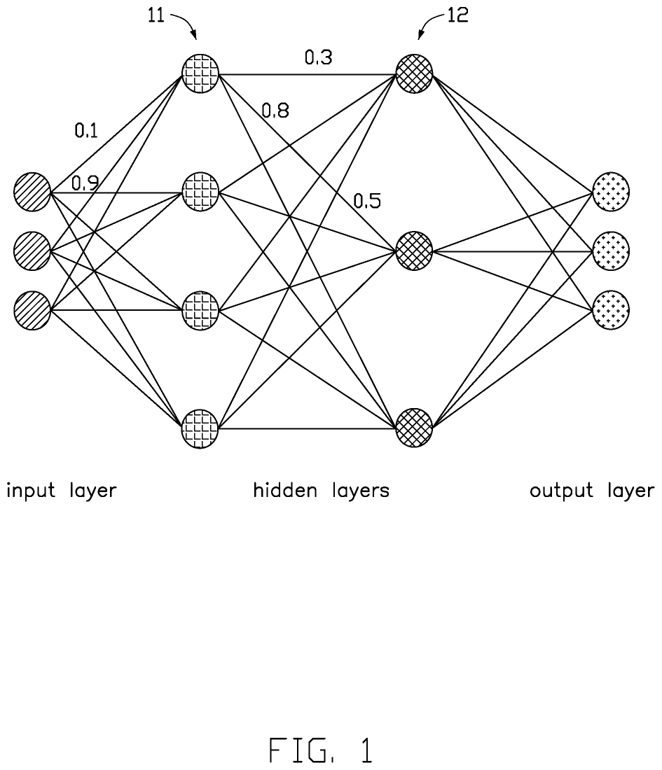

FIG. 1 shows a neural network of an embodiment of the present disclosure. The neural network is a computational model consisting of a plurality of nodes (or neurons) connected to each other. Each of the plurality of nodes represents an activation function. The nodes are distributed in a plurality of layers arranged in order of computation. Each of the nodes is connected to all the nodes of a followed neighboring layer. A connection between each two connected nodes represents a weight value for passing a signal.

In at least one embodiment, the neural network includes an input layer, a plurality of hidden layers, and an output layer. The input layer, the hidden layers, and the output layer are arranged in order of computation. The neural network shown in FIG. 1 has two hidden layers.

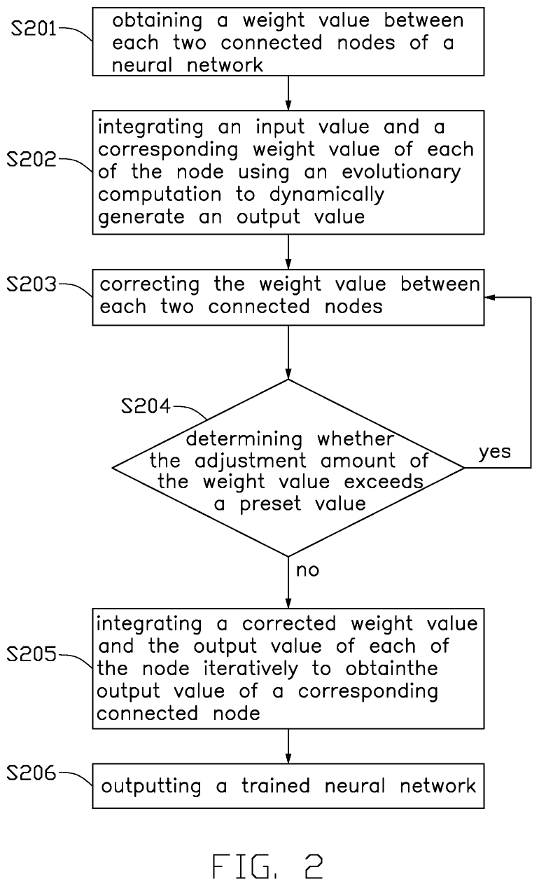

A neural network training method is illustrated in FIG. 2. The method is provided by way of embodiments, as there are a variety of ways to carry out the method. Each block shown in FIG. 2 represents one or more processes, methods, or subroutines carried out in the example method. The method can begin at block S201.

At block S201, the weight value between each two connected nodes of the neural network is obtained.

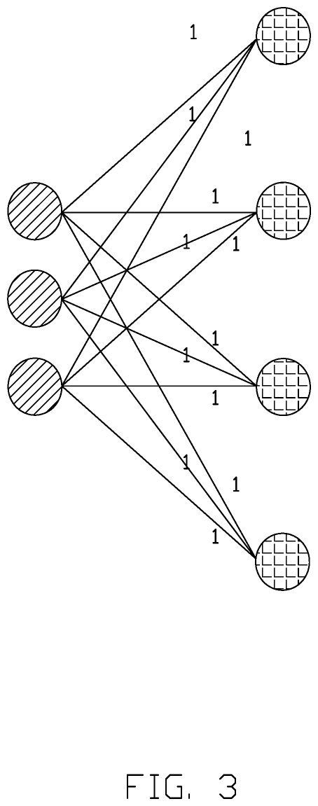

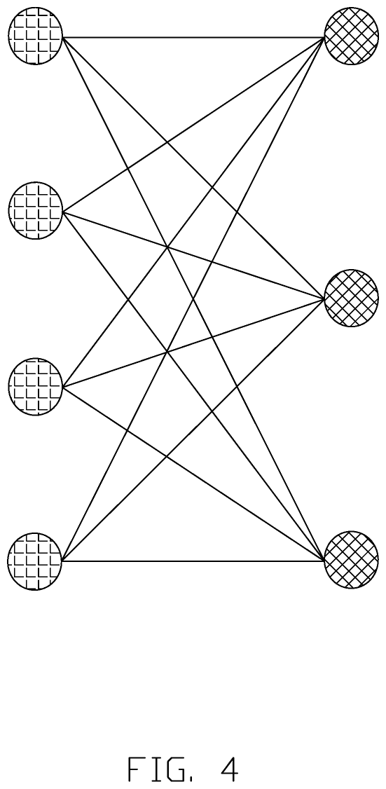

Specifically, in at least one embodiment, a first hidden layer 11 and the input layer form a first network structure as shown in FIG. 3, and a second hidden layer 12 and the output layer form a second network structure as shown in FIG. 4. It can be assumed that the weight value between each two connected nodes is 1, thereby obtaining an initial data.

At block S202, an output value of each of the nodes is dynamically generated by integrating an input value and a corresponding weight value of the node according to an evolutionary computation.

Specifically, the output value of the node is consistent with an input value of a corresponding connected node of a followed neighboring layer.

A function of the evolutionary computation is

$${a}_{i} = g ( {\sum }_{j = 1}^{N} {ω}_{ji} {a}_{j} ) ,$$

where N represents a number of nodes of the neural network, j=1, 2, 3 . . . N−1, i=j+1, ωⱼᵢ represents the weight value between two connected nodes, aᵢ and aⱼ represent output values of the two connected nodes, and aⱼrepresents the output value of the node of a followed neighboring layer.

Specifically, g represents a neuron function generated from a given data, such as the initial data, and can be dynamically changed.

At block S203, the weight value between each two connected nodes is corrected.

Specifically, a corrected weight value can be obtained by using a gradient descent method. It can be assumed that the weight value between each two connected nodes is 1, and a corrected weight value can be 0.1, 0.9, 0.3, 0.5, 0.8, and the like. The weight value can be corrected by synthesizing the output values of nodes of the same layer.

At block S204, a determination is made as to whether an amount of adjustment of the weight value exceeds a preset value.

Specifically, if the adjustment exceeds the preset value, the method proceeds to block 203. If the adjustment does not exceed the preset value, the method proceeds to block 205.

At block S205, the corrected weight value and the output value of each of the nodes are integrated iteratively to obtain the output value of a corresponding connected node of a followed neighboring layer.

At block S206, a trained neural network as shown in FIG. 1 is output.

The evolutionary computation is performed through at least two iterations, and if a number of iterations satisfies a preset condition or the output value reaches a convergence condition, the method ends. If the convergence condition is not reached, the method proceeds to a next iteration.

The evolutionary computation simulates the competition for survival of the biological world and the principle of survival of the fittest. A plurality of possible solutions are randomly generated, and then mating, copying, mutation, and other means are employed to evaluate these solutions, to gradually eliminate bad solutions, and to leave good solutions. Each elimination is a generation, and usually a maximum quantity of generations is defined to stop the evolution. The maximum quantity of generations is configured with a population that satisfies a preset condition.

Individuals of an initial population are randomly generated, and all the individuals are replaced by mating, copying, and mutation operations to obtain a first generation. The first generation continues to evolve until the maximum quantity of generations (G_MAX) is generated. When a perfect individual appears, the evolutionary computation can be terminated.

A best performing individual, such as the perfect individual, is selected from a terminated population as a result of the evolutionary computation.

Specifically, a population P is defined and N possible solutions (or individuals) are randomly generated. The N possible solutions are put into the population P. The population P can be seen as the nodes of the input layer in the present disclosure. The generation G starts from 0, and Q is defined as an empty set. If |Q| is less than |P|−1, two individuals are selected from the population for mating to generate a new solution, and the new solution is put into Q. If |Q| is greater than or equal to |P|−1, one individual is randomly selected from the population for copying to generate a new solution and the new solution is put into Q. Or it can be that one individual is randomly selected from the population for mutation to generate a new solution and the new solution is put into Q. If |Q| is equal to |P|, the value of G is increased by 1. The above operation is repeated until the value of G is equal to the G_MAX.

It should be noted that the neuron function g is dynamically changed, and the neuron function g can be generated according to the given data. Therefore, the neural network training method provided by the present disclosure can make the neural network better adapt to different data and obtain higher accuracy.

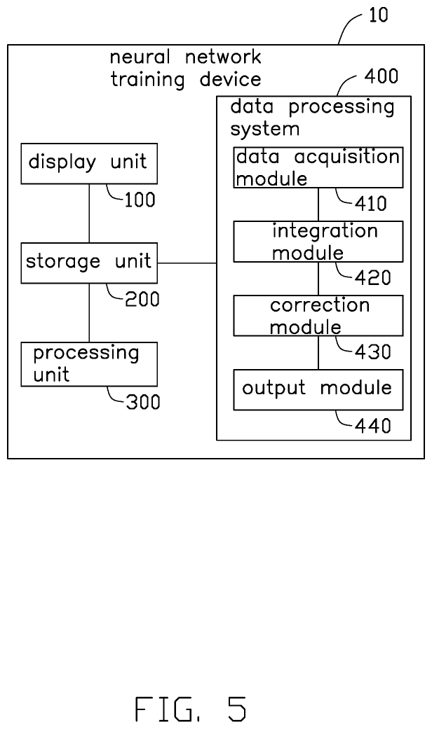

FIG. 5 shows a neural network training device 10, including a display unit 100, a storage unit 200, and a processing unit 300. The display unit 100, the storage unit 200, and the processing unit 300 are electrically connected to each other.

The display unit 100 is configured for displaying processing results of the processing unit 300. The display unit 100 includes at least one display.

The storage unit 200 is configured for storing various types of data of the neural network training device 10, such as program codes. The storage unit 200 allows automatic access to data during operation of the neural network training device 10. The various types of data include, but are not limited to, the weight value for each of the nodes, activation function for evolutionary computation, and preset gradient descents.

The storage unit 200 can be a read-only memory, a random access memory, a programmable read-only memory, an erasable programmable read-only memory, a one-time programmable read-only memory, or an electrically-erasable programmable read-only memory. The storage unit 200 can be an optical disk storage, a magnetic disk storage, a magnetic tape storage, or any other medium readable by a computer that can be used to store data.

The processing unit 300 can be a central processing unit, a micro processing unit, or a digital processing chip. The processing unit 30 is further configured for controlling the display unit 100 to display the neural network.

FIG. 5 shows a data processing system 400 running in the neural network training device 10. The data processing system 400 includes computer instructions in the form of one or more programs. The computer instructions are stored in the storage unit 200 and executed by the processing unit 300.

In at least one embodiment, the data processing system 400 as shown in FIG. 5 includes a data acquisition module 410, an integration module 420, a correction module 430, and an output module 440.

The data acquisition module 410 is configured for acquiring the weight value and the input value of each of the nodes.

The integration module 420 is configured for integrating the input value and the corresponding weight value of the node with the evolutionary computation, to dynamically generate the output value of the node. The function of the evolutionary computation is

$${a}_{i} = g ( {\sum }_{j = 1}^{N} {ω}_{ji} {a}_{j} ) ,$$

where N represents a number of nodes of the neural network, j=1, 2, 3 . . . N−1, i=j+1, o represents the weight value between two connected nodes, aᵢ and aⱼ represent output values of the two connected nodes, and aⱼ represents the output value of the node of a followed neighboring layer. Letter g represents a neuron function generated from the given data, and can be dynamically changed.

The integration module 420 is further configured for determining the number of iterations. If the number of iterations satisfies the preset condition or if the output value reaches the convergence condition, a trained neural network is obtained. Until the convergence condition is reached, the method proceeds to next iteration.

The correction module 430 is configured for correcting the weight value by synthesizing the output values of the nodes of the same layer. Specifically, the corrected weight value can be obtained by the correction module 430 using the gradient descent method.

The correction module 430 is further configured for determining whether to perform next iteration according to the amount of adjustment of the weight value. If the adjustment exceeds the preset value, the weight value is again corrected. If the adjustment does not exceed the preset value, the corrected weight value is integrated with the output value of each of the nodes to obtain the output value of a corresponding connected node.

The output module 440 is configured for outputting the trained neural network.

The present disclosure also provides a computer storage medium. The computer storage medium stores computer program codes. The computer program codes are for executing the neural network training method on a computer.

A person skilled in the art can understand that all or part of the process in the above embodiments can be implemented by a computer program stored in a computer readable storage medium. Flow of an embodiment of the methods as described above may be executed by the programs.

In addition, each functional unit in each embodiment of the present invention may be integrated in one processor, or each unit may exist physically separately, or two or more units may be integrated in one same unit. The above integrated unit can be implemented in the form of hardware or in the form of hardware plus software function modules.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A neural network training method, comprising:
obtaining a weight value between each two connected nodes of a neural network, wherein the neural network comprises a plurality of nodes and each of the plurality of nodes represents an activation function, the nodes are distributed in a plurality of layers arranged in order of computation, and each of the nodes is connected to all the nodes of a followed neighboring layer and a connection between each two connected nodes represents the weight value;
integrating an input value and a corresponding weight value of each of the nodes using an evolutionary computation to dynamically generate an output value, and the output value of the node is consistent with an input value of a corresponding connected node of a followed neighboring layer;
correcting the weight value between each two connected nodes;
integrating a corrected weight value and the output value of each of the nodes iteratively to obtain the output value of a corresponding connected node of a followed neighboring layer; and
outputting a trained neural network.

2. The neural network training method as claimed in claim 1, wherein a function of the evolutionary computation is
$${a}_{i} = g ( {\sum }_{j = 1}^{N} {ω}_{ji} {a}_{j} ) ,$$
N represents a number of nodes of the neural network, j=1, 2, 3 . . . N−1, i=j+1, ωⱼᵢ represents the weight value between two connected nodes, aᵢ and aⱼ represent output values of the two connected nodes, and aⱼ represents the output value of the node of a followed neighboring layer.

3. The neural network training method as claimed in claim 2, wherein g represents a neuron function generated from a given data and is capable of being dynamically changed.

4. The neural network training method as claimed in claim 1, wherein the evolutionary computation is performed through at least two iterations.

5. The neural network training method as claimed in claim 4, wherein if a number of iterations satisfies a preset condition or the output value reaches a convergence condition, the trained neural network is obtained; if the convergence condition is not reached, proceeds to next iteration.

6. The neural network training method as claimed in claim 1, the method of correcting the weight value between each two connected nodes comprises synthesizing the output values of the nodes of a same layer to obtain a corrected weight value between the two connected nodes.

7. The neural network training method as claimed in claim 6, the method of synthesizing the output values of node of the same layer to obtain the corrected weight value between the two connected nodes comprises:
correcting the weight value using a gradient descent method; and
determining whether to perform the iteration based on an amount of adjustment of the weight value.

8. The neural network training method as claimed in claim 7, wherein if the adjustment of the weight value exceeds a preset value, correcting the weight value again.

9. The neural network training method as claimed in claim 1, wherein the neural network comprises an input layer, a plurality of hidden layers and an output layer, and the input layer, the hidden layers and the output layer are arranged in order of computation.

10. A neural network training device, comprising:
a display unit;
a storage unit; and
a processing unit,
wherein the storage unit stores a plurality of program modules, the plurality of program modules are executed by the processing unit and perform the followed neighboring steps:
obtaining a weight value between each two connected nodes of a neural network, wherein the neural network comprises a plurality of nodes and each of the plurality of nodes represents an activation function, the nodes are distributed in a plurality of layers arranged in order of computation, and each of the nodes is connected to all the nodes of a followed neighboring layer and a connection between each two connected nodes represents the weight value;
integrating an input value and a corresponding weight value of each of the nodes using an evolutionary computation to dynamically generate an output value, and the output value of the node is consistent with an input value of a corresponding connected node of a followed neighboring layer;
correcting the weight value between each two connected nodes;
integrating a corrected weight value and the output value of each of the nodes iteratively to obtain the output value of a corresponding connected node of a followed neighboring layer; and
outputting a trained neural network.

11. The neural network training device as claimed in claim 10, wherein a function of the evolutionary computation is
$${a}_{i} = g ( {\sum }_{j = 1}^{N} {ω}_{ji} {a}_{j} ) ,$$
N represents a number of nodes of the neural network, j=1, 2, 3 . . . N−1, i=j+1, ωⱼᵢ represents the weight value between two connected nodes, aᵢ and aⱼ represent output values of the two connected nodes, and aⱼ represents the output value of the node of a followed neighboring layer.

12. The neural network training device as claimed in claim 11, wherein g represents a neuron function generated from a given data and is capable of being dynamically changed.

13. The neural network training device as claimed in claim 10, wherein the evolutionary computation is performed through at least two iterations.

14. The neural network training device as claimed in claim 13, if a number of iterations satisfies a preset condition or the output value reaches a convergence condition, the trained neural network is obtained; if the convergence condition is not reached, proceeds to next iteration.

15. The neural network training device as claimed in claim 10, the method of correcting the weight value between each two connected nodes comprises synthesizing the output values of the nodes of a same layer to obtain a corrected weight value between the two connected nodes.

16. The neural network training device as claimed in claim 15, the method of synthesizing the output values of node of the same layer to obtain the corrected weight value between the two connected nodes comprises:
correcting the weight value using a gradient descent method; and
determining whether to perform the iteration based on an amount of adjustment of the weight value.

17. The neural network training device as claimed in claim 16, wherein if the adjustment of the weight value exceeds a preset value, correcting the weight value again.

18. The neural network training device as claimed in claim 10, wherein the neural network comprises an input layer, a plurality of hidden layers and an output layer, and the input layer, the hidden layers and the output layer are arranged in order of computation.

19. A computer storage medium, configuring for storing computer programs codes for executing a neural network training method, wherein the neural network training method comprises:
obtaining a weight value between each two connected nodes of a neural network, wherein the neural network comprises a plurality of nodes and each of the plurality of nodes represents an activation function, the nodes are distributed in a plurality of layers arranged in order of computation, and each of the nodes is connected to all the nodes of a followed neighboring layer and a connection between each two connected nodes represents the weight value;
integrating an input value and a corresponding weight value of each of the nodes using an evolutionary computation to dynamically generate an output value, and the output value of the node is consistent with an input value of a corresponding connected node of a followed neighboring layer;
correcting the weight value between each two connected nodes;
integrating a corrected weight value and the output value of each of the nodes iteratively to obtain the output value of a corresponding connected node of a followed neighboring layer; and
outputting a trained neural network.

20. The computer storage medium as claimed in claim 19, wherein a function of the evolutionary computation is
$${a}_{i} = g ( {\sum }_{j = 1}^{N} {ω}_{ji} {a}_{j} ) ,$$
N represents a number of nodes of the neural network, j=1, 2, 3 . . . N−1, i=j+1, ωⱼᵢ represents the weight value between two connected nodes, aᵢ and aⱼ represent output values of the two connected nodes, and aⱼ represents the output value of the node of a followed neighboring layer.
